(19) United States
(12) Patent Application Publication
(10) Pub. No.: US 2024/0154506 A1
(43) Pub. Date: May 9, 2024

(54) METHOD FOR PRODUCING A ROTOR FOR AN ELECTRIC MACHINE

(71) Applicant: AUDI AG, Ingolstadt (DE)

(72) Inventors: Martin GERNGROSS, Kinding (DE); Florian HUSEMEIER, Altmannstein (DE)

(21) Appl. No.: 18/499,952

(22) Filed: Nov. 1, 2023

(30) Foreign Application Priority Data
Nov. 4, 2022 (DE) 102022129147.2

(51) Int. Cl. H02K 15/09; H02K 15/02

(52) U.S. Cl. CPC H02K 15/09; H02K 15/026; H02K 2215/00

(57) ABSTRACT

A method is provided for producing a rotor for an electric machine, wherein the rotor comprises a shaft and a sheet metal pack arranged on the shaft, the sheet metal pack including a plurality of individual metal sheets axially stacked in succession, wherein multiple poles are provided on the sheet metal pack, around which wires are wound to form individual windings, wherein a sheet metal pack is used having multiple axially running breaches through it, wherein a tie rod is led through each breach of the sheet metal pack prior to the winding around the poles and locked at one end for the axial tensioning of the sheet metal pack, after which the wires are wound around the poles. A rotor produced according to the described method and an electric machine comprising a rotor are also provided.

### BACKGROUND

### Technical Field

The present disclosure relates to a method for producing a rotor for an electric machine, wherein the rotor comprises a shaft and a sheet metal pack arranged on this, consisting of a plurality of individual metal sheets axially stacked in succession, wherein multiple poles are provided on the sheet metal pack, around which wires are wound to form individual windings. A rotor produced according to the described method, and an electric machine having a rotor is also provided.

### Description of the Related Art

An electric machine generally comprises a stator, as well as a rotor, usually arranged in the stator, and rotating about an axis of rotation relative to the stator, which is fixed in its position. The rotor generally consists of a shaft and a sheet metal pack arranged on this, which in turn consists of a plurality, usually several hundred, of individual metal sheets having a sheet thickness of usually less than 1 mm, the individual metal sheets being axially stacked in succession. The individual metal sheets are usually punched out from a thin metal strip in a punching process. Moreover, multiple poles projecting radially outward are formed on the sheet metal pack, i.e., sheet metal pack sections running axially and parallel to the shaft, in order to wind the wires to form individual windings in appropriately tight packing.

As described, the individual metal sheets are punched out from a metal strip. Depending on the process, punching bun may form on the punched edges of the individual metal sheets. The sheet metal pack itself is shrink-fitted onto the shaft, for which the sheet metal pack is heated and/or the rotor shaft is cooled, so that the heating results in an expansion or the cooling results in a shrinkage. After the assembly of the sheet metal pack on the shaft and a following temperature equalization, an extremely firm shrink fit results. As a result of the burr formed during the punching process, the shrink-fitted sheet metal pack may have narrow air gaps between the individual sheet layers, that is, the metal sheets within the sheet metal pack are not stacked entirely free of air gaps. Although the individual air gaps are extremely narrow and lie in the range of a few microns, the individual air gaps still add up to a corresponding air gap volume. These air gaps result in problems during the later winding of the sheet metal pack with wire. The first wire windings or winding layers are stretched tight around the pole, since the axial clamping force applied by the individual winding layers to the sheet metal pack is relatively slight. But with increasing number of winding layers, the axial clamping force increases, resulting in the metal sheets being slightly axially compacted, i.e., pressed together, decreasing the air gap volume. This, in turn, means that the first wire winding layers lose their pretensioning or winding tension, i.e., they are no longer wound sufficiently tight and further winding layers might no longer be placed properly. On the whole, this may lead to a lower degree of copper fill of the wires made of copper and thus a worse efficiency of the rotor.

The integration of continuous rods in the sheet metal pack is known from the document EP 2 608 363 A1. There, however, the rods are set in place only after the winding of the winding poles, in order to secure axially end-positioned flange components on the end faces of the rotor.

A method is known from the document US 2011/0 074 242 A1 in which corresponding tie rods are likewise set in place on the rotor sheet metal pack. But these serve there solely for adjusting the stiffness of the sheet metal pack, the individual rods being individually tensioned, i.e., tightened with individual clamping force, in order to define a corresponding clamping pattern, which is then used for rotors of the same model. The rotor there has no poles, but instead lengthwise running grooves, in which corresponding copper rods are inserted.

### BRIEF SUMMARY

Embodiments of the present disclosure provide a production method which is improved compared to the prior method mentioned above.

An example embodiment of a method is provided wherein a sheet metal pack is used having multiple axially running breaches through it, wherein a tie rod is led through each breach of the sheet metal pack prior to the winding around the poles and locked at one end for the axial tensioning of the sheet metal pack, after which the wires are wound around the poles.

In the method described herein, the sheet metal pack is axially tensioned with special advantage prior to the winding of the poles and any air gap volume is reduced for the most part or almost entirely, after which the wire windings are placed on the poles only in this condition. In order to reduce the air gap volume, a sheet metal pack is used having multiple axially continuous breaches, through which the tie rods, also called draw bars, are led for the axial tensioning. These are axially locked, i.e., secured with respect to the sheet metal packs, wherein this locking exerts an axial clamping force on the sheet metal pack, pressing the individual metal sheets together.

In some embodiments, this axial tensioning of the sheet metal pack may occur prior to its mounting on the shaft, that is, the individual metal sheets are stacked to form the sheet metal pack and then the corresponding tie rods are inserted and tensioned, after which the already tensioned sheet metal pack is shrink-fitted onto the shaft. Alternatively, however, it is also possible to first stack the sheet metal pack and shrink-fit it on the shaft, and only then set the tie rods in place and tension them axially in order to compact the sheet metal pack.

Regardless, in any case, at the time when the windings are put in place the sheet metal pack is axially tensioned and almost free of air gaps. This means that, when winding the individual winding layers, no geometry change of the sheet metal pack will occur on account of the increasing axial force of the resulting winding that is exerted on the tightly wound wire layers and neither will the tightness of the winding of the first winding layers change. This, in turn, means that the following winding layers can likewise be wound correctly positioned and with the required tensioning, so that on the whole a very high degree of copper fill results and the winding as such will have the desired winding geometry.

In some embodiments, the axial clamping force exerted via the tie rods may be adjusted such that the air volume is almost entirely expelled. Even if the marginally remaining air volume is still expelled through the winding process and the sheet metal pack is still marginally compacted axially, this changes nothing with regard to the winding tension, since the axial pack change is negligible. In some embodiments, however, the air volume will be completely expelled, so that all metal sheets are completely clamped on the block. This, in turn, means that, after setting the tie rods or draw bars in place, the sheet metal pack geometry is finally established and will no longer change during the winding process.

Advisedly, a sheet metal pack is used in which the breaches are provided in at least one part of the poles. This is helpful in that the windings are placed on the poles so that their direct axial tensioning is feasible by a securing of the sheet metal pack geometry.

In some embodiments, a breach may be provided in each pole, so that a tie rod can be inserted in each pole. Consequently, the same tension conditions can be established in each pole, so that the windings can all be configured practically identical. The breaches in the sheet metal pack are advisedly made as boreholes, and the tie rods are round rods in cross section. The borehole diameter corresponds as precisely as possible to the rod diameter, so that the tie rods are held in the sheet metal pack with only minimal play. This assures that the metal volume of the sheet metal pack is not needlessly reduced by too much play within the breaches.

For the axial tensioning of the sheet metal pack, it is necessary to fix, i.e., lock the tie rods axially at both ends of the pack. The locking may occur in different ways. In some embodiments, the locking of the tie rods may be done by nuts screwed onto threaded sections at the end of the tie rods. That is, only two end-positioned nuts have to be screwed on for the locking, being axially braced, and the pre-clamping force can be varied depending on how strongly the nuts are tightened. Alternatively, it is also conceivable for each tie rod to be locked by a form-fitting connection produced by a forming process. This form-fitting connection can be produced, for example, by clinching.

In some embodiments, each nut or form-fitting connection is situated in a recess provided in an axial end face of the sheet metal pack. The nut or the form-fitting connection is thus recessed on the end faces. Thus, it does not engage with the outermost sheet layer, but instead with a sheet layer situated somewhat in the interior of the pack, where it is axially braced. The few outer sheet layers, not directly tensioned in this way, can easily be axially tensioned by the individual windings themselves. This axial tensioning can be done by star discs regularly placed on the axial end faces of the sheet metal pack, being also wound inside the individual windings, i.e., enclosed by them. The star discs are not tensioned by the tie rods, but instead are otherwise fixed in place, but in any case they are clamped axially against the pole by the windings. Thanks to the recessed arrangement of the nuts or the form-fitting connections, a flat abutment of the star discs against the end face of the sheet metal pack is possible.

Alternatively, it is also conceivable, prior to the locking of the tie rods at the two ends of the sheet metal pack, to place a respective star disc axially thereon, and each nut or form-fitting connection is situated either in a recess provided in an axial end face of the star disc or placed on the axial end face of the star disc. The entire axial structure consisting of the two star discs and the sheet metal pack is axially tensioned here by the tie rods, while the corresponding locking connections, i.e., the nuts or the form-fitting connections, can either be arranged recessed on the star discs or be placed axially on top of them.

Furthermore, it is conceivable to release the tie rods after the winding of the poles from their locking and remove them from the sheet metal pack. This is possible if the tie rods are in a position on the poles in which they are not wrapped around by the windings, looking axially. If the tie rods are arranged on the radially outer head ends of the poles with a regular T shape in cross section, they will not be involved in the winding, and so can be pulled out once more if need be. Alternatively, they may also be left in place.

### BRIEF DESCRIPTION OF THE SEVERAL VIEWS OF THE DRAWINGS

Further benefits and details will emerge from the following explained embodiments and figures.

FIG. 1 shows a diagram of a rotor during its assembly, in an exploded view.

FIG. 2 shows an enlarged partial view of a sheet of a sheet metal pack.

FIG. 3 shows a cross sectioned representation of the rotor of FIG. 1 in the final assembled state with indicated windings.

FIG. 4 shows the rotor of FIG. 1 with star discs put in place and indicated windings.

FIG. 5 shows a second embodiment of a rotor not showing the windings.

FIG. 6 shows a third embodiment of a rotor.

### DETAILED DESCRIPTION

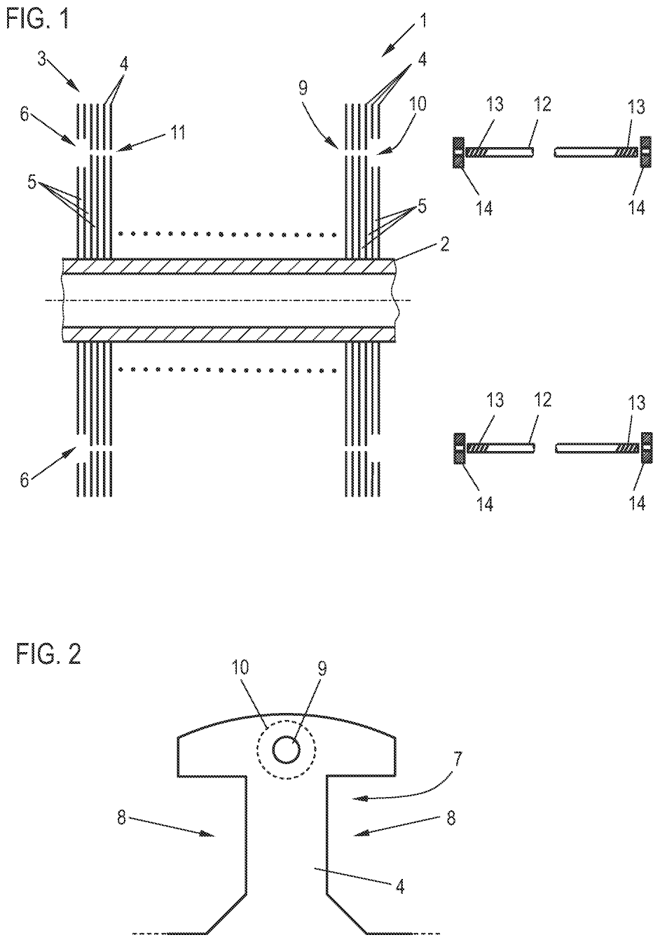

FIG. 1 shows, to explain the method described herein, a rotor 1 during assembly in an exploded view. The rotor 1 has a hollow shaft 2, on which is arranged a sheet metal pack 3 consisting of a multitude of individual metal sheets 4, usually several hundred of them. The sheet metal pack 3 is shrink-fitted onto the shaft 2 in familiar fashion.

Air gaps 5 are present between the metal sheets 4, being shown greatly exaggerated in the drawing for representation purposes. These air gaps 5 result from punching burr remaining on the punching contour during the punching of the individual metal sheets 4 from a metal strip, with the individual adjacent metal sheets 4 lying against each other across these gaps. Because of this punching bun, they cannot be placed on the shaft 2 free of air gaps. The air gaps 5 lie in the range of a few μm, being shown greatly exaggerated in FIG. 1, as mentioned.

Multiple poles 6 are formed on the sheet metal pack 3, for which each individual sheet 4 as in FIG. 2 has a corresponding pole section 7 showing a more or less T-shaped cross section, so that, looking from the end face of the sheet metal pack 3, the respective pole 6 is likewise T-shaped in cross section. Corresponding winding grooves 8 are formed at each pole 6, in which a subsequently applied wire winding is wound to form the respective winding.

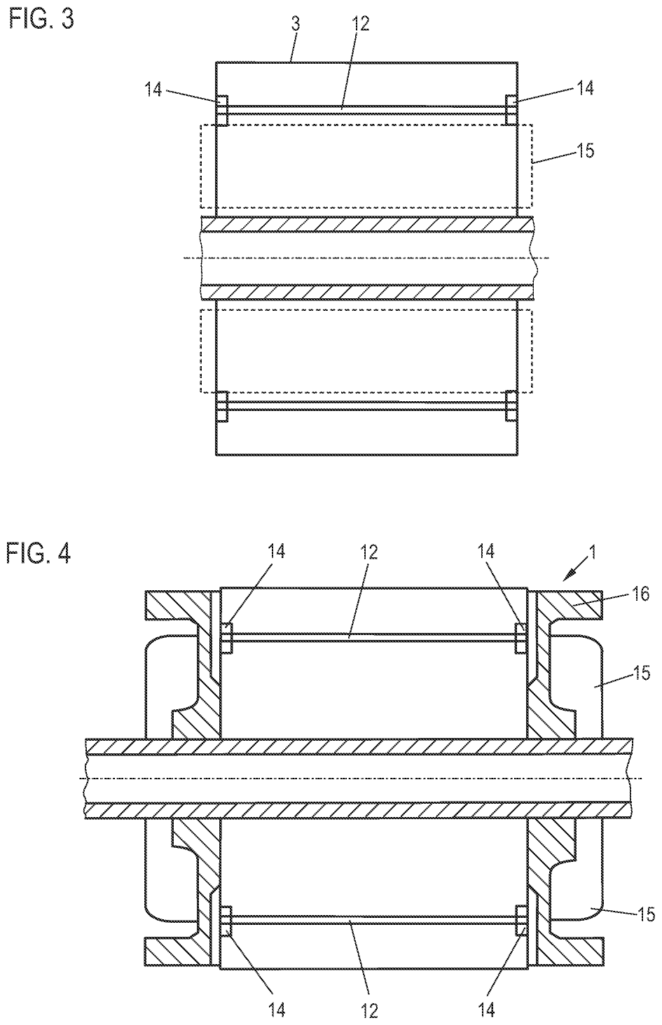

The sheet metal pack 3, or each sheet 4, has a breach 9 in the form of a circular round borehole in the region of the pole 6 or the pole section 7, while a few of the end-positioned metal sheets 4 in the embodiment shown also have an enlarged breach 10, as shown by dotted line in FIG. 2, serving for the countersunk receiving of a nut, as will be further described below. The metal sheets 4 are arranged such that the breaches 9 or 10 are all aligned with each other, so that a breach 11 running through the sheet metal pack 3 is formed. This breach 11 serves for the axial tensioning of the sheet metal pack 3, not yet free of air gaps, as shown in FIG. 1. The tie rods 12 are used for this, as shown in FIG. 1. The tie rods, likewise round in cross section, are provided with a thread 13 on their end, so that a corresponding nut 14 can be screwed onto them. After the shrink-fitting of the sheet metal pack 3 (but also possibly already before the shrink-fitting of the sheet metal pack 3 in one variant of the method), i.e., when the individual metal sheets 4 have been stacked in succession, the tie rods 12 are shoved into the respective breaches 11 and the nuts 14 are screwed onto the ends. The nuts 14 are tightened so that the entire sheet metal pack 3 is axially tensioned, as shown in FIG. 3. This means that the metal sheets 4, at least in the area of the poles 6, have been axially pressed against each other almost or entirely free of air gaps, i.e., the sheet metal pack 3 has been axially tensioned. This has the effect that a geometry change of the sheet metal pack 3 in the area of the pole 6 is no longer possible during the subsequent winding of the poles with a wire to form the respective pole-side winding 15, i.e., after this axial tensioning, and consequently the wire tension in each wire winding also remains unchanged as the winding process proceeds. In FIG. 3, two wrapped windings 15 are shown by dashed lines. The individual wire windings or winding layers run in the respective winding grooves 8. Since the axial pretensioning which is exerted by the screwed-in tie rods 12 on the sheet metal pack 3 is at least equal to, but in some embodiments greater than the entire axial pretensioning which is applied through the individual windings 15 or the entirety of the individual winding layers of a winding 15 on the respective pole 6, it is ensured that this winding-side pre-clamping force does not result in a further compaction of the already tensioned pole 6 due to the winding process.

FIG. 4 shows the rotor 1 of the preceding figures, but here in addition there are shown two star discs 16 placed on the axial end faces, being wound into the respective windings 15 as shown in FIG. 3. Due to the countersunk arrangement of the nuts 14, the respective star disc 16 can be placed flat on the end face of the sheet metal pack 3, i.e., they are braced axially as much as possible against the sheet metal pack 3. During the winding process to form the winding 15, no further geometry change that might adversely affect the tensioning of the winding layers in any way will occur in the area of the star discs 16 and their bracing.

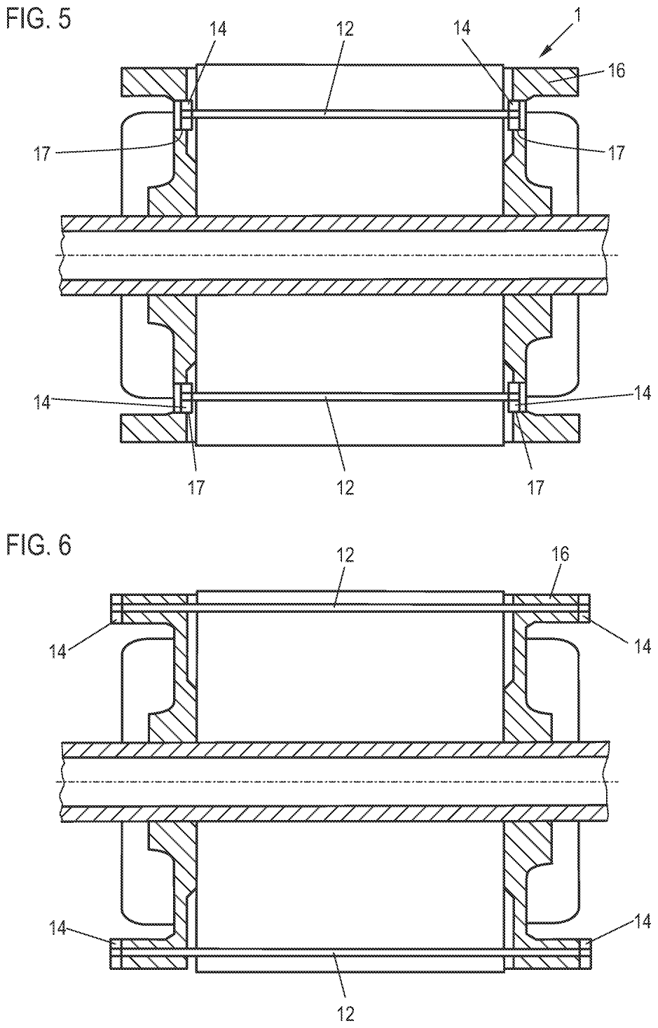

FIG. 5 shows a second embodiment of a rotor 1, the layout of which corresponds to that of the preceding figure. In this embodiment, however, all of the metal sheets 4 are identical in form and all of them have only the small breach 9 or borehole in which the tie rod 12 is inserted. However, the tie rod 12 in this embodiment is longer, also extending through corresponding boreholes in the end-positioned star discs 16. The respective nuts 14 are received in corresponding indentations 17 on the respective star discs, i.e., once again they are countersunk and braced axially against the star discs 16. In terms of mounting technique, this means that the star discs 16 are positioned before placing the tie rods 12 and screwing them tight with the nuts 14, unlike in the embodiment described above where the star discs 16 are positioned only after the tensioning of the sheet metal pack. Even so, in this embodiment as well, an almost complete or a complete compacting of the sheet metal pack 3 free of air gaps is achieved, since the star discs 16 are braced axially directly and flat against the axial end faces of the sheet metal pack 3.

Basically, the possibility exists of leaving the tie rods 12 along with the nuts 14 in the rotor even after applying the windings 15, which is necessary if the nuts 14 have been axially wound over. But it would also be conceivable to loosen the nuts 14 once more and remove the tie rods 12 if the breaches 11 lie radially outward and are not in the wound region of the poles 6. This changes nothing about the geometry of the sheet metal pack 3 since the sheet metal pack 3 is axially tensioned and fixed by the respective tightly wound windings 15.

An embodiment of a rotor is shown in FIG. 6, next to the embodiment of FIG. 1. The breaches 11 and thus the tie rods 12 here lie further to the outside against the poles, so that they are not wound over. The nuts 14 here are also arranged, for example, at the end face, lying against the respective star discs 16. A recessed arrangement would also be conceivable. In any case, the nuts are accessible even after the winding process and can therefore be loosened afterwards, so that the tie rods 12 can be removed, thus reducing the weight of the rotor 1.

German patent application no. 10 2022 129147.2, filed Nov. 4, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for producing a rotor for an electric machine, wherein the rotor comprises a shaft and a sheet metal pack arranged on the shaft, the method comprising:
stacking axially a plurality of individual metal sheets in succession to form the sheet metal pack, wherein multiple poles are provided on the sheet metal pack, and wherein multiple axially running breaches extend through the sheet metal pack;
leading a respective tie rod through each breach of the sheet metal pack;
axial tensioning the sheet metal pack via the tie rods; and
after the sheet metal pack is axially tensioned, winding wires around the poles to form individual windings.

2. The method according to claim 1, wherein the breaches are provided in at least part of the poles of the sheet metal pack.

3. The method according to claim 2, wherein a respective breach is provided in each pole and the respective tie rod is led through each pole.

4. The method according to claim 1, wherein the breaches are formed as boreholes in the sheet metal pack.

5. The method according to claim 1, wherein axial tensioning of the sheet metal pack includes locking of the tie rods by nuts screwed onto threaded sections at the end of the tie rods or by a form-fitting connection of the tie rod to the sheet metal pack produced by a forming process.

6. The method according to claim 5, wherein each nut or form-fitting connection is situated in a recess provided in an axial end face of the sheet metal pack.

7. The method according to claim 5, wherein prior to the locking of the tie rods, a respective star disc is placed axially on one of opposing ends of the sheet metal pack, and each nut or form-fitting connection is situated in a recess provided in an axial end face of the star disc or placed on the axial end face of the star disc.

8. The method according to claim 1, wherein, after winding the wires around the poles, the tie rods are released and removed from the sheet metal pack.

9. A rotor, produced according to the method according to claim 1.

10. An electric machine, comprising a rotor produced according to the method according to claim 1.
